(19) United States
(12) Patent Application Publication
(10) Pub. No.: US 2005/0098100 A1
(43) Pub. Date: May 12, 2005

(54) Pig design for use with application materials

(76) Inventors: Herbert Martin, Weinstadt (DE); Andreas Collmer, Vaihingen (DE); Martin Stiegler, Steinheim (DE); Manfred Michelfelder, Steinheim (DE)

Correspondence Address: Gregory D. DeGrazia;Howard & Howard Attorneys, PC, Suite 101, 39400 Woodward Avenue, Bloomfield Hills, MI, 48304-5151, US

(21) Appl. No.: 10/652,095

(22) Filed: Aug. 29, 2003

(30) Foreign Application Priority Data
Aug. 30, 2002 (DE) DE102 40 072.5

(51) Int. Cl. B05C 11/00; B05B 15/00

(52) U.S. Cl. 118/679; 118/684

(57) ABSTRACT

The two sealing lips of a pig, which is driven by a pushing medium for delivering a coating material for the mass-production coating of workpieces, have a self-sharpening sealing edge contacting the inner wall of the piggable line. Flat outer surface parts of the sealing lip formed ahead of and behind the sealing edge are angled against the inner wall of the line for an unloaded pig, while the inner surface part in the axial direction is pressed flat against the line under loading by the pushing medium. The production of the pig is realized through turning and subsequent shaping of the sealing lips in a transport sleeve in which the pig is kept and brought to its insertion location.

The invention concerns a pig for delivering a coating material and a method for its production according to the preamble of the independent claims.

For example, the pig can be used for delivering coating material and solvent or thinner media in known systems for electrostatic coating of workpieces, such as vehicle chassis (DE 198 30 029, EP 0 904 848, EP 1 172 152, EP 1 172 153, EP 1 108 475, etc.). The pig is driven by a fluid or gaseous pushing medium.

For such purposes, numerous requirements, some of which are difficult to fulfill, are placed on the pig. These requirements among others include, small construction size and the ability to traverse tubes of relatively small radii, adjustment of the sealing force for rising pushing pressure, movability in two directions, and a perfect seal for slow movements (e.g., less than 1 m/s). For the configuration of insulating sections in lines of electrostatic systems, the pig should guarantee complete evacuation of the line through residue-free scraping of fluid from the tube walls. It is further essential that a pig with flexible sealing lips adjust automatically to the more-or-less tolerance-restricted inner diameter of the tube and also easily overcome unevennesses and small obstacles, e.g., between the piggable tube and the connected pig stations, without negatively affecting the sealing function (dynamic seal). Especially important is a lifetime (service life) for the pig that is as high as possible, since a certain amount of wear and tear cannot be avoided during the course of operation.

A pig known from EP 1 108 475 for a painting device consists of a rigid base body and elastomer body parts, which are attached to the base body with a locking connection, which form the ends, and which carry circular sealing lips that are inclined diagonally to the longitudinal direction, that are concentric in the peripheral direction, and that should “rake” the inside of the tube with convex rounded ends. If excess pressure is generated on the thrust side by means of the pushing medium, then the corresponding sealing lip is pressed against the inner wall of the line under initial stress, which provides an especially good cleaning of the inside wall. This known pig fulfills most of the requirements mentioned above, but has the disadvantage that during scraping by the rounded ends of its sealing lips in contact with the walls of the inner line, it loses its seal relatively quickly and must be replaced.

The goal of the invention, starting with these conditions, is a pig, which remains functional longer than previously even for unavoidable wear and tear.

This problem is solved by the features of the claims.

For the pig according to the invention, the sealing lips become worn during the course of operation on a defined surface such that the sealing edge contacting the inner wall of the piggable line is constantly and automatically resharpened and, thus, even after long wear and tear, still guarantees the required sealing and scraping effect. If only the surface part of the outer surface of the sealing lip bordering the sealing edge on the inside in the axial direction is uniformly worn under the pressure of the pig pushing medium, the angle between the two adjacent outer surface parts and thus the scraping behavior of the pig determined by the sharpness of the sealing edge is maintained up to a predetermined degree of wear without loss of quality.

This is an essential advantage compared with known pigs, whose quality continuously declines during operation. In comparison with the previously used pigs (EP 1 108 475), there results a significantly increased service life of the pig. By practical tests, it was determined, e.g., that after more than 10,000 cycles in a typical line section of a coating system, the original sealing edge and the two adjacent, essentially flat surface parts were still present, and merely the location of the sealing edge corresponding to the wear of the surface part pressed against the inner line wall had been shifted. The similarly preserved bevels formed by the angle between the surface parts in front of and behind the sealing edge and the inner line wall are also important for traversing projecting edges of the line.

In addition, the pig described here fulfills all of the requirements mentioned in the introduction, e.g., for an electrostatic coating system. Among other things, it ensures, even more so than before, the required dynamic seal during the coating operation through optimum adaptation of the flexible lips to the inner diameter of the tubes and their transition points and the important, complete evacuation of line sections without leaving behind fluid residue on the walls of the inner line scraped by the pig during spraying of electrically conductive paint under high voltage for producing insulating segments. The pig remains sealed both for slow and high speeds. In addition, the shape and configuration of the pig described here provides significantly better sealing force of the sealing lips in comparison with known pigs under the pressure of the pushing medium of the pig acting on the inner surface of the sealing lip. For example, to a significantly greater extent than previously used pigs the higher the viscosity of the paint to be delivered, and thus the pushing pressure, the higher will be the sealing force of the sealing lips.

For the required flexibility of the sealing lips, which determines the state of the seal and resistance to wear, and thus the operating security of the pig, the correct selection of the thickness of the sealing lips is the decisive factor, but the thickness can be different according to the selected material. In particular, for the production of the pig from PE (polyethylene), which has proven to be advantageous, the thickness of the part of the sealing lip forming an inner part of the pig is preferably equal to between 2% and 10% of the outer diameter of the sealing edge of the pig in its operating position in the piggable line. At the sealing edge, the sealing lip can be somewhat thicker than in the region of the adjacent surfaces, which has the advantage that the sealing edge is pressed better against the inner wall of the line due to the static pretensioning of the sealing lip.

The length of the sealing lip also contributes to its advantageous properties. In a preferred embodiment, the length of the connection point of the sealing lip with the inner part of the pig up to its sealing edge equals more than two times its thickness at the sealing edge.

In addition to the previously mentioned polyethylene (PE), the materials for producing the pig can theoretically also include other plastics, e.g., polytetrafluoroethylene (PTFE), polypropylene (PP), polyamide (PA), polyurethane (PUR), polymethyl methacrylate (PMMA), polyvinyl chloride (PVC), polycarbonate (PC), polyoxymethylene (POM), polystyrene (PS), or combinations of these materials.

Preferably, however, the pig consists of a material that has a low percentage of plastic deformation and thus maintains an elastic stress even for long-term deformation. This is advantageous because the sealing effect of the pig then barely weakens even for long use in the deformed state.

In addition, the pig preferably consists of a material that exhibits both low friction and elastic deformation behavior. The low friction of the pig material is advantageous because the pig can then be moved with low force through the piggable line. In contrast, the elastic deformation behavior is advantageous for a good sealing effect. The elasticity modulus of the pig material therefore preferably lies in the range of 200 N/mm² to 5000 N/mm², where any intermediate values are possible.

According to a preferred embodiment, a surface part of the sealing lip running between the outer surface part of the sealing lip on the inside and the position of its connection to an inner part of the pig is separated by a cut from an adjacent contact surface of the pig. This surface part can be pressed against this contact surface. The cut should be as narrow as possible according to production and ensures support of the sealing lip for stronger loading, e.g., at a projecting edge in the piggable line, without the risk of damaging the lip, e.g., by folding over.

Preferably, on both sides of the pig, there are spacer parts defining its axial position relative to external parts of the coating system and/or other pigs and projecting over the axial end of the sealing lips. For example, in this way, precisely defined positions of adjacent pigs in supply and discharge channels of valve housings can be ensured. Simultaneously, the spacer parts also protect the sealing lips from damage when contacting other pigs or end stops.

According to another advantageous feature of the invention, if the pig contains a magnetic element, which is used in coating systems in a known way for reporting the appearance of the pig at a defined line position or at valve stations or the like, the additional problem may arise that the pig must reach the reporting point with the correct polarity of the magnetic element. If the pig is inserted with the opposite side into the line system, it can generate false report signals. In addition, the individual pigs should be inserted into the piggable line, so that they repel adjacent pigs, so that the adjacent pigs can be separated in a pig station. Therefore, the symbols “N” and “S” have been printed on the two sides of previously used pigs, which, however, are so inconspicuous that they are often overlooked or confused.

This problem is solved according to the invention by providing color markings with different colors on opposite axial sides of the pig for identifying the magnetic poles. For example, the pig can be produced from two identical parts, which are connected to each other in the axial direction and which consist of differently painted material.

In contrast, in another embodiment, the pig has at least one partially transparent sleeve in which a color-coded magnetic element is inserted. For example, the sleeve can consist of a transparent plastic, while the two poles of the magnetic element are painted or coated differently. The operating personnel can then recognize the orientation of the pig through the sleeve with reference to the color configuration of the magnetic element.

Instead of a magnetic element, the pig for signal transmission can also include an iron element, which preferably consists of a soft-magnetic material and which can be magnetized by a magnet located outside of the piggable line.

Furthermore, a dielectric element can also be arranged in the pig for signal transmission, wherein a sensor located outside of the piggable line can detect the dielectric properties within the line and thus recognize the pig.

For the production of the pig, it is particularly simple and advantageous to generate the contours of the pig body and the sealing lips through turning. Among other things, for reasons related to production, during the shaping of the sealing lips, which should have parts lying approximately parallel to the longitudinal axes of the pig, the sealing lips are preferably first produced so that they are to a large extent perpendicular to the longitudinal axis. The desired end shape can then be realized through shaping with a suitable tool and subsequent heating. Here, the memory behavior of the used material known for polymers can be influenced selectively and essentially better than before in very advantageous ways for the properties of the sealing lips.

The heating of the sealing lips can be realized directly in a transport sleeve in which the pig can then be kept until use at the insertion location, wherein the sealing lips are maintained constantly at their predetermined diameter size. The transport sleeve can then also be used directly for inserting the pig into the line system.

The invention is explained in more detail with reference to the embodiment illustrated in the drawing. Shown are:

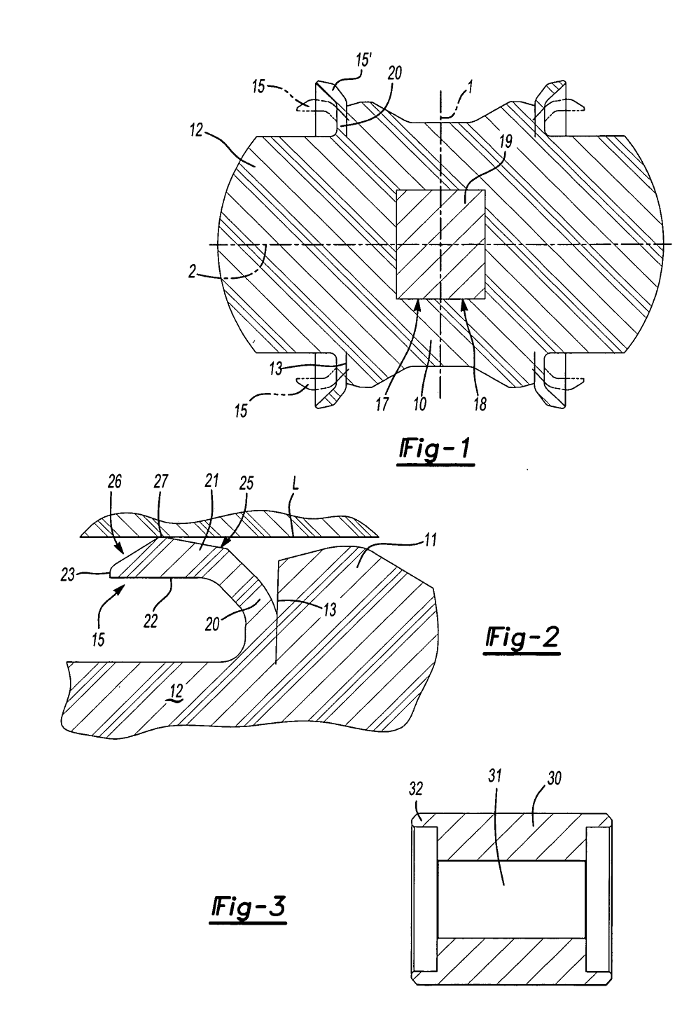

FIG. 1, an enlarged, to-scale longitudinal section along the axis of the pig, whose sealing lips are illustrated in two different positions;

FIG. 2, a highly enlarged partial sectional view of one of the sealing lips of the pig according to FIG. 1 in the operating position within the piggable line; and

FIG. 3, a longitudinal section along the axis of a transport sleeve for the pig according to FIG. 1 on a smaller scale.

The pig shown in FIG. 1 consists of two halves, which are mirror symmetrical in the axial direction with reference to the radial center plane indicated by 1 and which are rotationally symmetrical to the longitudinal axis 2. Each half consists of a cylindrical inner part 10, which transitions in the axial direction outwardly into a contact part 11 of the shown form expanding in the radial direction. A cylindrical spacer part 12 contacts this contact part. This spacer part can have a smaller diameter than the contact part 11 and ends in a convex rounded end surface in the axial direction according to the illustration. This end surface could also be flat.

The stop part 11 forms on its end perpendicular to the longitudinal axis 2 on the outside in the axial and radial directions an annular flat end surface 13, which is generated by a cut in the pig body and which extends up to approximately the diameter of the spacer part 12. The outer diameter of the stop part 11 should be only slightly smaller at the end surface 13 than the inner diameter of the piggable line in order to protect the sealing lip as described in the following.

At the outside in the axial direction, the sealing lip 15 is formed on the pig body adjacent to the end surface 13. The connecting plane, thus the transition between the inner end of the sealing lip and the main body of the pig runs axis-parallel according to the illustration between the cylindrical periphery of the spacer part 12 and the circular end of the recess forming the end surface 13. The sealing lip is illustrated in two different positions, namely, at 15, in the position that it assumes when the pig is inserted in the piggable line, and, at 15′, in a position it had originally at the production of the pig (explained further below).

The profile of the inner part of the sealing lip bent into the position shown at 15 is shown only schematically and need not correspond exactly to the actually produced shape. Apart from this, however, the contour of the sealing lip is reproduced to scale in FIG. 1 and in the enlarged detail view of FIG. 2, and in the position that is produced when the pig is located in the piggable line without loading by its pushing medium and forms contact only according to the elasticity-specific static pretensioning of its inner wall. Consequently, a disk-shaped or plate-shaped ring section 20 running outwards in the radial direction and bent into the shown position contacts the axis-parallel transition planes to the pig body initially with uniform thickness (can also be recognized in the unbent state in FIG. 1). The ring section 20 transitions into second flat ring section 21, which is bent outwards in the axial direction or inwards in the radial direction according to the illustration and whose surface 22 pointing inwards in the radial direction runs in a straight line and at least approximately parallel to the longitudinal axis 2 for an unloaded pig up to the outermost end 23 of the sealing lip 15. In contrast, the outer surface of the ring section 21 facing the straight-line inner wall L of the piggable line has two flat surface parts 25 and 26, respectively, bent in opposite directions to each other, e.g., by approximately 130° according to the illustration, which form the sealing lip between the sealing edge 27. The thickness of the ring section 21 thus constantly increases from the first ring section 20 up to the sealing edge 27, and from there decreases constantly up to the end 23. For the illustrated example, the sealing lip thus narrows constantly up to its thinnest point at its outermost end. The thickness of the sealing lip is selected according to the application depending on the material used and equals approximately 1/32 of the inner diameter of the inner wall L, where the sealing lip 15 makes contact, in the region of the ring section 20 for the illustrated example.

The angle ahead of and behind the sealing edge 27 between the inner wall L of the line and the outer surface part 26 or the inner surface part 25 in the axial direction and also particularly the adjacent surface of the ring section 20 forms the bevels of the sealing lip 15, which are important, among other things, for problem-free traversal of possible projecting edges in or on the line. However, the position of the surface parts 25 and 26 is also important for the automatic resharpening of the sealing lip edge produced by the invention. In the illustrated position without loading by the pushing medium, the angle between the inner wall L of the piggable line and the surface part 25 should equal more than, e.g., 5°, but less than approximately 20°; in the illustrated example, it equals less than approximately 10°. The angle forming the outer bevel in the axial direction between the surface part 26 and the inner wall L can be greater according to the illustration, here, approximately more than 30°.

In contrast, when the pig is driven by the pushing medium, its pressure acts uniformly on the entire inner surface of the periphery of the spacer part 12 over the adjacent surface of the first ring section 20 and the surface 22 of the second ring section 21 up to the end 23. Due to the illustrated shape of the sealing lip 15, this pressure distribution acts so that the pressure force of the pushing medium acts mainly in the axial direction behind the sealing edge 27 and thus pushes the surface part 25 at least approximately parallel to the longitudinal axis 2 and against the inner wall L, so that despite resulting wear and tear of this surface, the sealing edge 27 remains unchanged.

For practical embodiments of the illustrated pig with a nominal diameter of the sealing lip of 16 mm for use in typical tube lines of a coating system for mass-production coating of workpieces, the thickness of the sealing lip 15 in the region of the ring section 20 can preferably equal 0.5 mm. For a similar pig for the same purpose with a nominal diameter of 9 mm, the corresponding thickness can equal 0.4 mm. Starting with these numbers, other dimensions can be determined from the drawing.

For producing the illustrated pig, e.g., by turning, initially two cylindrical blanks are formed from elastic plastic e.g., PE, with outer diameters dimensioned according to the given purpose.

In end surfaces of the two blanks facing each other, cylindrical recesses 17 and 18, respectively, which are coaxial to the longitudinal axis, are formed (FIG. 1). After the cylindrical magnetic element 19, also illustrated in FIG. 1, has been inserted into one of the recesses, the two blanks are rigidly connected together, e.g., by welding or adhesion.

Then preferably and through new turning work, the contours of the pig body and the sealing lips are formed into the shape shown in FIG. 1, with the sealing lips receiving the shape and attitude shown at 15′. Simultaneously or afterwards, the recess or cut-out in the magnetic body forming the end surface 13 is realized.

Then, the pig produced thus far is inserted into a cylindrical interior of a shaping tool, which has a diameter equal to the nominal diameter of the pig or the inner diameter of the piggable line and is longer than the resulting axial distance of the outermost ends of the two sealing lips of the pig in the axial direction. The sealing lips are pivoted from the position shown at 15′ by an imaginary point of rotation D (or around the coaxial circle there) into the position shown at 15. In the tool, the pig is heated so that the sealing lips are transformed under selective influence of the memory behavior of the used plastic into its final shape, in which they are somewhat farther apart in the radial direction from the pig body than in the position shown at 15, when the pig is located outside of the piggable line, but are also then bent into a shape with an outer diameter that is smaller than that shown at 15′. In the transformation tool, the pig has the same shape and position of the sealing lips as in FIG. 2.

For setting the correct magnetic field strengths of the magnetic element 19, the pig can be subjected to remagnetization.

According to a special feature of the invention already mentioned in the introduction, color markings with different colors should be provided on opposite sides of the pig in the axial direction for identifying the magnetic poles of the magnetic element 19. For this purpose, for the described production of the pig, a material painted with another color is used for the two mirror-symmetric halves (e.g., one pig half can be blue and the other pig half can be painted red).

However, as an alternative it is also possible for the magnetic element 19 to have two colors, while the pig consists of a transparent material, so that the operating personnel can immediately recognize the orientation of the pig.

For transport and insertion of the pig, one can advantageously use the transport sleeve 30 shown in FIG. 3. The pig is kept in this sleeve until it is ready to use and is transported in this sleeve to its insertion location. Therefore, the pig is permanently protected and guarded against changes to its sealing lips. The length of the cylindrical interior 31 receiving the pig is larger for the illustrated example than the total axial length of the pig. It is especially advantageous if the pig is inserted from the transport sleeve 30 directly into the piggable line system. For this purpose, the transport sleeve 30 has ring elements 32 on both sides that project in the axial.

1. A pig for delivering a coating material through a piggable line of a system for the mass-production coating of workpieces comprising:
a pig part;
two flexible sealing lips which are separated from each other along a longitudinal axis of the pig part and which are coaxial to the longitudinal axis, and which project in the radial direction from the pig part, and each sealing lip having a circular outer surface coaxial to the longitudinal axis facing outwards in the radial direction, wherein the sealing lips can bend from a rest position, in which the lips are set outside of the piggable line, inwards in the radial direction into an operating position within a piggable line, and wherein each sealing lip (15) has a sealing edge positioned between substantially flat surface parts, and that the sealing lip is shaped and configured so that in the operating position one of the surface parts extends in the axial direction from the sealing edge towards the other sealing lip and lies substantially parallel to the longitudinal axis of the pig part.

2. (canceled)

3. (canceled)

4. The pig according to claim 1 wherein the two surface parts of each sealing lip define an angle of 130° at the sealing edge.

5. The pig according to claim 1 wherein each sealing lip includes an inner surface (22) opposite the sealing edge extending substantially parallel to the longitudinal axis of the pig part.

6. The pig according to claim 1 wherein a thickness of each sealing lip decreases as the lip extends from the sealing edge.

7. The pig according to claim 1 wherein a length of the sealing lip between the sealing edge and the connecting point with the pig part is greater than a thickness of the lip at the sealing edge.

8. The pig according to claim 7 wherein the length is at least twice the thickness.

9-13. (canceled)

14. The pig according to claim 1 further comprising:
a magnetic element disposed in the pig part.

15. (canceled)

16. The pig according to claim 14 further comprising:
color markings on opposite sides of the pig part in the axial direction with different colors for identifying magnetic poles of the magnetic element.

17. The pig according to claim 16 further comprising:
a sleeve surrounding the magnetic element wherein the sleeve is at least partially transparent.

18-25. (canceled)

26. A pig for moving coating material through a conduit comprising:
a substantially cylindrical body; and
a first radial lip having a length and thickness and integrally formed with the body and including a resilient ring section extending from the body and an outer section extending from the resilient ring section to an end portion and having first and second outer surfaces angled with respect to one another and a sealing edge defined between the first and second outer surfaces.

27. The pig according to claim 26 wherein the thickness of the outer section is variable.

28. The pig according to claim 27 wherein the thickness increases from the resilient ring section to the sealing edge.

29. The pig according to claim 27 wherein the thickness decreases from the sealing edge to the end.

30. The pig according to claim 26 wherein the length of the first radial lip from the sealing edge to the cylindrical body is greater than twice the thickness of the first radial lip at the sealing edge.

31. The pig according to claim 26 wherein a material for forming the cylindrical body is selected from the group consisting of polyethylene, polytetrafluroethylene, polypropylene, polyamide, polyurethane, polymethyl methacrylate, polyvinyl chloride, polycarbonate, polyoxymethylene, and polystyrene.

32. The pig according to claim 26 further comprising:
a stop part extending radially from the substantially cylindrical body adjacent to the resilient ring section.

33. The pig according to claim 26 further comprising:
a second radial lip having a second length and second thickness and integrally formed with the body and including a second resilient ring section extending from the body and a second outer section extending from the second resilient ring section to a second end portion and having third and fourth outer surfaces angled with respect to one another and a second sealing edge defined between the third and fourth outer surfaces.

34. The pig according to claim 33 wherein the second radial lip is in mirrored relation to the first radial lip.

35. The pig according to claim 34 further comprising:
a second stop part extending radially from the substantially cylindrical body adjacent to the second resilient ring section.

36. The pig according to claim 35 wherein the second stop part is in mirrored relation to the stop part.

37-43. (canceled)

44. A pig manufactured according to the method of claim 37 for moving coating material through a conduit comprising:
a substantially cylindrical body; and
a first radial lip having a length and thickness and integrally formed with the body and including a resilient ring section extending from the body and an outer section extending from the resilient ring section to an end portion and having first and second outer surfaces angled with respect to one another and a sealing edge defined between the first and second outer surfaces.

45. A pig for delivering coating through a line of a system for coating workpieces, comprising:
a body portion having a longitudinal axis, opposed end portions and a midportion between said end portions;
sealing lips including a generally radial portion integral with said midportion of said body portion and generally axial end portions extending outwardly toward said end portions of said body portion; and
said midportion of said body portion including a radial contact portion between said sealing lips having radial surfaces opposite said generally radial portions of said sealing lips preventing said sealing lips from being deformed axially beyond said contact portion.

46. The pig as defined in claim 45 wherein said generally radial portion of said sealing lips are cut from said radial contact portion by a radial cut.

47. The pig as defined in claim 45 wherein said sealing lips have a thickness of between two percent and ten percent of the outer diameter of said generally axial portion of said sealing lips.

48. The pig as defined in claim 45 wherein said generally axial portion of said sealing lips includes opposed first and second faces intersecting at an apex defining a self-sharpening sealing edge.
